(19) United States
(12) Patent Application Publication
(10) Pub. No.: US 2019/0084817 A1
(43) Pub. Date: Mar. 21, 2019

(54) PIVOTING PRYBAR HEAD

(71) Applicant: RUQIAN ZHANG, XIAOSHAN HANGZHOU (CN)

(72) Inventor: RUQIAN ZHANG, XIAOSHAN HANGZHOU (CN)

(73) Assignee: TOOLRICH IMP. & EXP. CO., LTD., XIAOSHAN HANGZHOU (CN)

(21) Appl. No.: 15/705,753

(22) Filed: Sep. 15, 2017

(51) Int. Cl. B66F 15/00

(52) U.S. Cl. CPC B66F 15/00

(57) ABSTRACT

A prybar has a handle shaft. A first prybar end extends from the handle shaft. The first prybar end includes a first prybar end first fork tine and a first prybar end second fork tine. A pivot head extends from the handle shaft. The pivot head includes a first pivot head button and a second pivot head button. A second prybar end extends from the pivot head. The second prybar end rotates on the pivot head relative to the handle shaft when the first pivot head button and the second pivot head button are depressed. A first handle retaining arm and a second handle retaining arm extends from the second prybar end. The first handle retaining arm and the second handle retaining arm are parallel and form a handle shaft slot. The handle shaft extends into the handle shaft slot.

### FIELD OF THE INVENTION

The present invention is in the field of prybars.

### DISCUSSION OF RELATED ART

A variety of different prybars have been used for demolition. Pivoting tool heads have improved the functionality of a variety of different hand tools, and utilize a variety of different locking mechanisms. Adjustable pry bars have begun to emerge in the marketplace. These tools utilize pivoting heads to allow the pry bars to be adjusted angularly. Often they are comprised of locking devices with spring mechanisms.

A variety of different adjustable pry bars and locking systems are described in the US patents. For example, Inventor Stawarski, in U.S. Pat. No. 2,921,773, issued Apr. 29, 2014 provides for an adjustable pry bar which includes a cap retention ring a push button retainer clip holding together a coupling sub-assembly. It also utilizes a spring system that enables rotary movement of the handle relative to the tool.

Inventor Spirer in U.S. Pat. No. 5,871,204, issued Feb. 16, 1999 utilizes a mounting pin to mount a pry bar head to the handle. When the mounting pin is mounted to the pry bar head, the retaining pin is threaded through the aperture to extend into the grove of the pin and thereby preventing the pin and the head from being displaced. Likewise, Inventor Cole in U.S. Pat. No. 7,682,099 entitled Indexable, Lockable Pivoting Mechanism For Hand Tool, issued Mar. 23, 2010 describes a similar device. This hand told comprises a 3 member mechanism along with a splined pin assembly that allows users to move the pin axially within the first two members between the locked and unlocked position to adjust the tool.

Inventor Whelan in U.S. Pat. No. 7,025,331B2 and published Apr. 11, 2006 discloses a prying tool that consists of a head portion and a handle portion that doubles as a tool head. Embodiments of the invention also include a tool head having an aperture with a predetermined shape that can be mated with a projection from a handle. The prying head can be positioned relative to an angle of the handle portion and can be detached to allow for a variety of positions.

U.S. Pat. No. 7,278,626B1 entitled Adjustable Prying Bar and published Oct. 9, 2007 by Inventor Pi-Hsia Chang describes an adjustable device that uses a hexagonal plate and spring to allow for adjustable angles greater or smaller than 90 degrees. The tool is comprised of a prying head, a flat tipped lower end wherein a lug has a circular depression and an inverse stop ring, a handle engaged with the upper end of the prying head having flat frond end with a hexagon hole therein engaged within the lug of the prying head, and a checking mechanism including an upper cover, a lower cover, a hexagon plate and a spring separately engaged with the lug.

Inventor Mou-Tan Liou in U.S. Pat. No. 8,201,806 and published Jun. 19, 2012 presents a pivoting prybar that encompasses a tool with a through-hole. A positioning device is disposed at the through-hole, the positioned hole and the cavity and is movable between a fixing position and an adjusting position. The positioning device consists of a controller, a resilient member and a retaining member.

U.S. Pat. No. 8,297,596 entitled Manually Operated Prying Tool by Inventor Cheng-Wei Su and published on Oct. 30, 2012 details a prying tool that includes a prying head and a handle. The head is defined at its end with an assembling hole where the head portion of the handle tool, a ratchet wheel, a C-shaped ring, a central shaft, a spring tool and a stopping piece is disposed. By pushing the central shaft, the prying tool can be switched into a fixing mode, an adjustment mode, or a rotation mode where users can rotate the tool to perform micro-angle adjustments between the prying head and the handle of the prying tool.

### SUMMARY OF THE INVENTION

A prybar has a handle shaft. A first prybar end extends from the handle shaft. The first prybar end includes a first prybar end first fork tine and a first prybar end second fork tine. A pivot head extends from the handle shaft. The pivot head includes a first pivot head button and a second pivot head button. A second prybar end extends from the pivot head. The second prybar end rotates on the pivot head relative to the handle shaft when the first pivot head button and the second pivot head button are depressed. A first handle retaining arm and a second handle retaining arm extends from the second prybar end. The first handle retaining arm and the second handle retaining arm are parallel and form a handle shaft slot. The handle shaft extends into the handle shaft slot. The first pivot head button is mounted to the first handle retaining arm and the second pivot head button is mounted to the second handle retaining arm.

The prybar also optionally includes a first sliding face formed on the first pivot head button, and a second sliding face formed on the second pivot head button. The first sliding face engages a shaped opening formed on the handle shaft, and the second sliding face also engages a shaped opening formed on the handle shaft. The shaped opening are preferably both a hexagonal shaped opening. The first sliding face and second sliding face are preferably both a hexagonal shaped sliding face. The first button retainer has a first button retainer opening that receives the first pivot head button, and the second button retainer has a second button retainer opening that receives the second pivot head button. The first button retainer and the second button retainer both fit on retainer recesses formed on a first handle retaining arm and a second handle retaining arm.

The first pivot head button and a second pivot head button both have a spring recess, namely a first pivot head button spring recess and a second pivot head button spring recess. A helical spring is mounted in compression between the first pivot head button recess and the second pivot head button recess. The helical spring biases the first pivot head button away from the second pivot head button.

### BRIEF DESCRIPTION OF THE DRAWINGS

FIG. 1 is a perspective view of the prybar.

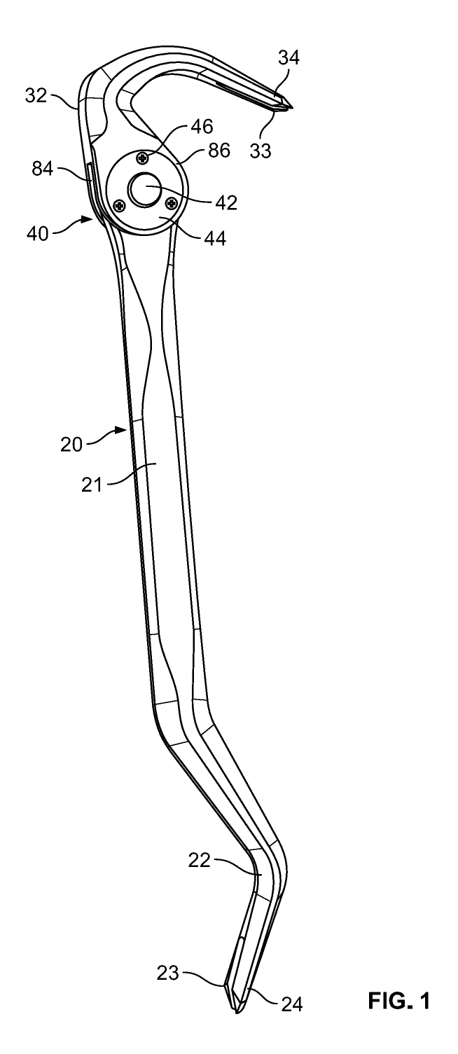

FIG. 2 is a perspective left side exploded view of the prybar pivot head.

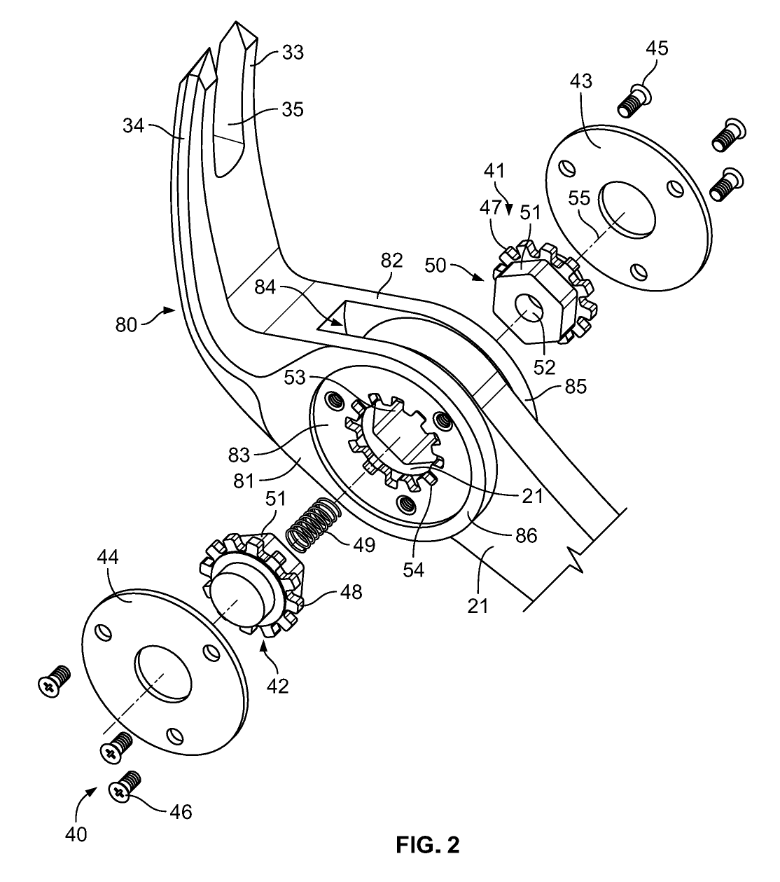

FIG. 3 is a perspective right side exploded view of the prybar pivot head.

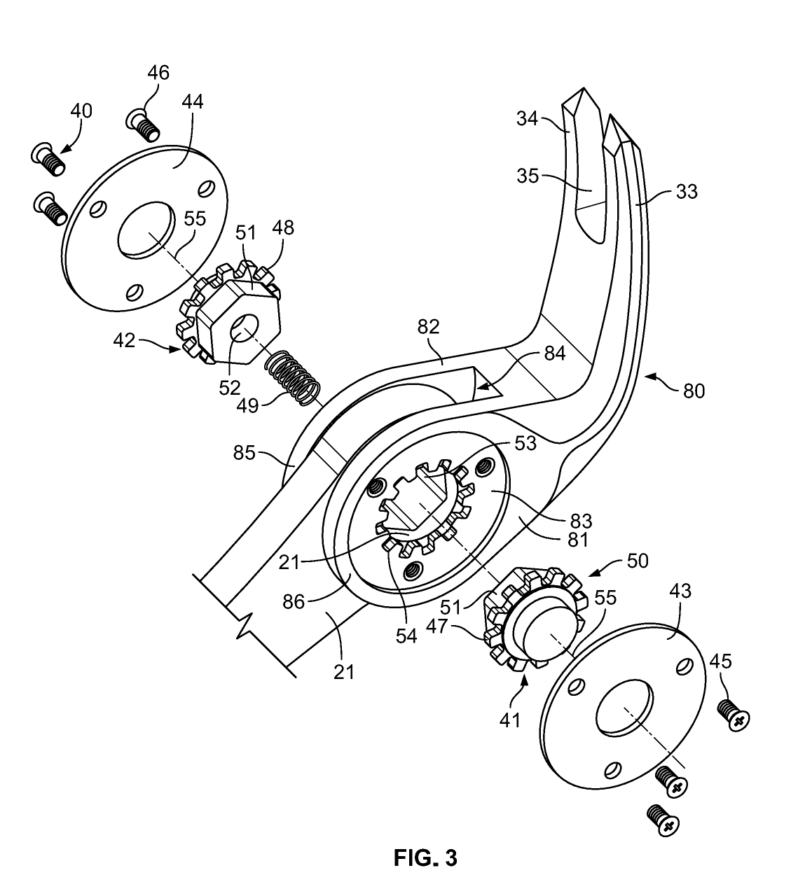

The following call out list of elements can be useful guide in referencing the call out numbers of the drawings.
20 Prybar
21 Handle Shaft
22 Second Prybar End
23 Second Prybar End First Fork Tine
24 Second Prybar End Second Fork Tine
32 First Prybar End
33 First Prybar End First Fork Tine
34 First Prybar End Second Fork Tine
35 Slot
40 Pivot Head
41 First Pivot Head Button
42 Second Pivot Head Button
43 First Button Retainer
44 Second Button Retainer
45 First Button Retainer Connectors
46 Second Button Retainer Connectors
47 First Button Sprocket
48 Second Button Sprocket
49 Helical Spring
50 Locking Mechanism
51 Sliding Hexagonal Face
52 Spring Recess
53 Hexagonal Shaped Opening
54 Retaining Arm Sprocket Cut Out
55 Button Axis
80 Pivoting Portion
81 First Face
82 Second Face
83 Retainer Recess
84 Handle Shaft Slot
85 First Handle Retaining Arm
86 Second Handle Retaining Arm

### DETAILED DESCRIPTION OF THE PREFERRED EMBODIMENT

The present invention is a prybar 20 that has a handle shaft 21. The handle shaft 21 extends to a first prybar end 32. The first prybar end 32 has a first prybar end first fork tine 33 and a first prybar end second fork tine 34. Similarly, the handle shaft 21 extends to a second prybar end 22. The second prybar end 22 has a second prybar end first fork tine 23 and a second prybar end second fork tine 24. A slot 35 is formed between the fork tines.

The first prybar end can pivot on a pivot head 40. The pivot head 40 is made of the handle shaft 21 fitting in a handle shaft slot 84 defined between a pair of retaining arms, namely a first handle retaining arm 85 and a second handle retaining arm 86. Each of the pair of retaining arms pivotally mounts to the handle shaft 21. Preferably, the first face 81 has a retainer recess 83 and the second phase 82 also has a retainer recess 83. The retainer recess can be circular and a depression. The first retainer recess can receive a first button retainer 43, and the second retainer recess can receive a second button retainer 44. The first button retainer 43 and the second button retainer 44 have a central opening for receiving the first pivot head button 41 and the second pivot head button 42. The pivot head button is preferably a circular button that protrudes through the central opening of the button retainer.

The helical spring 49 fits between the pair of buttons. Each button has a spring recess 52. Each of the spring recesses 52 are formed in each of the buttons. The helical spring 49 pushes the buttons apart so that they abut against the button retainers. The button retainers including the first button retainer 43 and the second button retainer 44 have a circular opening that receives a circular protrusion of the button. The button rotates relative to the button retainer so that the first button sprocket 47 and the second button sprocket 48 are away from a level of the retaining arm sprocket cut out 54. The retaining arm sprocket cut out 54 matches the shape of the button sprocket so that the button can be engaged into the retaining arm sprocket cut out 54. The default position is that the helical spring 49 biases the button to pockets into the retaining arm sprocket cutouts 54, however the user can press the first pivot head button 41 and the second pivot head button 42 inward. When pushed inward, the first button sprocket and the second button sprocket are no longer aligned to and retained by the retaining arm sprocket cutouts 54. Once free, the first button sprocket and the second button sprocket can rotate relative to the retaining arm sprocket cut out 54.

The prybar head is therefore movable for adjustment when a user depresses both the first and second buttons. The prybar head ceases to become movable when the user releases either the first or second button. Upon release, the first button sprocket and the second button sprocket reengage into the retaining arm sprocket cutouts 54. The selectively rotatable prybar head provides a variety of different functions depending upon a users needs. The pair of buttons provides a locking mechanism 50 that locks the first face 81 and the second face 82 to the handle shaft 21.

The helical spring has a diameter that is smaller than the diameter of the face of the button. Similarly, the button retainer has a diameter that is larger than the face of the button. The handle shaft 21 preferably has a hexagonal shaped opening 53. The hexagonal shaped opening 53 receives a sliding hexagonal face 51 on the first and second pivot head button. The hexagonal face 51 slides into and out of the hexagonal shaped opening as the pair of buttons slide inward to disengage during an adjustment and outward to engage during usage.

The button sprocket has a plurality of radiating teeth such as between ten and eighteen teeth. The retaining arm sprocket cut out 54 has a similar number of radiating teeth to match the button sprocket. Preferably, the button sprockets are symmetrical such that they can be the same part number.

1. A prybar comprising:
a. a handle shaft;
b. a first prybar end extending from the handle shaft, wherein the first prybar end includes a first prybar end first fork tine and a first prybar end second fork tine;
c. a pivot head extending from the handle shaft, wherein the pivot head includes a first pivot head button and a second pivot head button;
d. a second prybar end extending from the pivot head, wherein the second prybar end rotates on the pivot head relative to the handle shaft when the first pivot head button and the second pivot head button are depressed; and
e. a first handle retaining arm and a second handle retaining arm extending from the second prybar end, wherein the first handle retaining arm in the second handle retaining arm are parallel and form a handle shaft slot, wherein the handle shaft extends into the handle shaft slot, wherein the first pivot head button is mounted to the first handle retaining arm and the second pivot head button is mounted to the second handle retaining arm.

2. The prybar of claim 1, further comprising:
a. a first sliding face formed on the first visit head button, and a second sliding face formed on the second pivot head button, wherein the first sliding face engages a shaped opening formed on the handle shaft, and wherein the second sliding face also engages a shaped opening formed on the handle shaft.

3. The prybar of claim 3, wherein the shaped opening is a hexagonal shaped opening, wherein the first sliding face and second sliding face are both a hexagonal shaped sliding face.

4. The prybar of claim 1, further including a first button retainer and a second button retainer, wherein the first button retainer has a first button retainer opening that receives the first pivot head button, wherein the second button retainer has a second button retainer opening that receives the second pivot head button.

5. The prybar of claim 4, wherein the first button retainer and the second button retainer both fit on retainer recesses formed on a first handle retaining arm and a second handle retaining arm.

6. The prybar of claim 1, wherein the first pivot head button and a second pivot head button both have a spring recess, namely a first pivot head button spring recess and a second pivot head button spring recess, wherein a helical spring is mounted in compression between the first pivot head button recess and the second pivot head button recess, wherein the helical spring biases the first pivot head button away from the second pivot head button.

7. The prybar of claim 6 further comprising:
a. a first sliding face formed on the first visit head button, and a second sliding face formed on the second pivot head button, wherein the first sliding face engages a shaped opening formed on the handle shaft, and wherein the second sliding face also engages a shaped opening formed on the handle shaft.

8. The prybar of claim 7, wherein the shaped opening is a hexagonal shaped opening, wherein the first sliding face and second sliding face are both a hexagonal shaped sliding face.

9. The prybar of claim 6, further including a first button retainer and a second button retainer, wherein the first button retainer has a first button retainer opening that receives the first pivot head button, wherein the second button retainer has a second button retainer opening that receives the second pivot head button.

10. The prybar of claim 9, wherein the first button retainer and the second button retainer both fit on retainer recesses formed on a first handle retaining arm and a second handle retaining arm.

11. The prybar of claim 1, wherein the helical spring biases the first pivot head button against the first button retainer, and wherein the helical spring biases the second pivot head button against the second button retainer.

12. A prybar comprising:
a. a handle shaft;
b. a first prybar end extending from the handle shaft;
c. a pivot head extending from the handle shaft, wherein the pivot head includes a first pivot head button and a second pivot head button;
d. a second prybar end extending from the pivot head, wherein the second prybar end rotates on the pivot head relative to the handle shaft when the first pivot head button and the second pivot head button are depressed, wherein the second prybar end includes a second prybar end first fork tine and a second prybar end second fork tine; and
e. a first handle retaining arm and a second handle retaining arm extending from the second prybar end, wherein the first handle retaining arm in the second handle retaining arm are parallel and form a handle shaft slot, wherein the handle shaft extends into the handle shaft slot, wherein the first pivot head button is mounted to the first handle retaining arm and the second pivot head button is mounted to the second handle retaining arm.

13. The prybar of claim 12, further comprising:
a. a first sliding face formed on the first visit head button, and a second sliding face formed on the second pivot head button, wherein the first sliding face engages a shaped opening formed on the handle shaft, and wherein the second sliding face also engages a shaped opening formed on the handle shaft.

14. The prybar of claim 13, wherein the shaped opening is a hexagonal shaped opening, wherein the first sliding face and second sliding face are both a hexagonal shaped sliding face.

15. The prybar of claim 12, further including a first button retainer and a second button retainer, wherein the first button retainer has a first button retainer opening that receives the first pivot head button, wherein the second button retainer has a second button retainer opening that receives the second pivot head button.

16. The prybar of claim 15, wherein the first button retainer and the second button retainer both fit on retainer recesses formed on a first handle retaining arm and a second handle retaining arm.

17. The prybar of claim 16, wherein the first pivot head button and a second pivot head button both have a spring recess, namely a first pivot head button spring recess and a second pivot head button spring recess, wherein a helical spring is mounted in compression between the first pivot head button recess and the second pivot head button recess, wherein the helical spring biases the first pivot head button away from the second pivot head button.
